(19) United States
(12) Patent Application Publication
(10) Pub. No.: US 2023/0158732 A1
(43) Pub. Date: May 25, 2023

(54) METHOD OF ADDITIVE LAYER MANUFACTURING

(71) Applicant: CAMBRIDGE ENTERPRISE LIMITED, Cambridge, Cambridgeshire (GB)

(72) Inventors: David Michael ROPER, Cambridge (GB); Serena Michelle BEST, Cambridge (GB); Kyung-Ah KWON, Cambridge (GB); Ruth Elizabeth CAMERON, Cambridge (GB)

(73) Assignee: CAMBRIDGE ENTERPRISE LIMITED, Cambridge, Cambridgeshire (GB)

(21) Appl. No.: 17/917,165

(22) PCT Filed: Apr. 6, 2021
(86) PCT No.: PCT/GB2021/050848

§ 371 Date: Oct. 5, 2022

(30) Foreign Application Priority Data
Apr. 6, 2020 (GB) 2005046.4

(51) Int. Cl. B29C 64/118; B29C 64/321; B29C 64/40; B33Y 10/00; B33Y 80/00

(52) U.S. Cl. CPC B29C 64/118; B29C 64/40; B29C 64/321; B33Y 10/00; B33Y 80/00; B29K 2995/0032; B29K 2995/0041; B29L 2031/753

(57) ABSTRACT

Various methods of additive layer manufacturing, and objects obtainable by such manufacturing, are disclosed. In particular, there is provided a method of additive layer manufacturing comprising depositing a layer of a material on a surface, and controlling the deposition to vary a material property of the material within the layer. There is also provided a method of additive layer manufacturing comprising depositing at least one layer of material on a sacrificial layer, the layer of material having a thickness of 400 microns or less, wherein the sacrificial layer is located on a base surface.

The present invention relates to a method of additive layer manufacturing, as well as objects obtainable by such a method.

### BACKGROUND TO THE INVENTION

Additive layer manufacturing, or 3D printing, is well known in the art. One known method of additive layer manufacturing is fused filament fabrication (also known as fused deposition modelling). This method uses a filament of material, which is fed through a heated print head and deposited on a surface (known as a print bed). The movement of the print head, and the rate at which material is fed to the head, is controlled in order to produce the desired shape of object from the printer. The material used is typically a polymeric material, and in particular a thermoplastic polymer.

However, conventional methods of additive layer manufacturing may have the problem that it is difficult to produce complex items, and in particular items requiring variation of physical or material properties within the item, particularly on a fine scale. To a certain extent, such variations can be achieved by printing adjacent layers formed of different materials (i.e. inter-layer variations), or layers with different materials in different rasters, but this can lead to weak points between the different materials, which are undesirable. Various arrangements have been proposed in which printing parameters can be varied in order to change the properties of the finished object. However, these documents again refer to varying properties between layers (i.e. inter-layer variations), which may not provide variations on a fine enough scale. Another problem associated with conventional methods of additive layer manufacturing is that it may be difficult to produce very thin parts, or parts with very thin layers, due to the difficulty in removing such parts from the printing surface and handling these parts after they have been printed by the print head.

It is an aim of the present invention to at least partially address the problems noted above.

### SUMMARY OF THE INVENTION

According to the present disclosure, there is provided a method of additive layer manufacturing comprising depositing a layer of a material on a surface and controlling the deposition to vary a material property of the material within the layer. That is, the variation in material property is an intra-layer variation.

Optionally, the method may include controlling the deposition to vary at least one of a material property of the material within the layer and the thickness of the layer, and/or controlling the deposition to vary the thickness of the layer (alone).

Optionally, the material is a polymer. Optionally, the polymer is PLLA (poly 1-lactic acid).

Optionally, the depositing is carried out by moving a print head in a first direction relative to the surface, and the variation of the material property is along the layer in the first direction

Optionally, the material property is polymer chain alignment.

Optionally, the material property is an optical property.

Optionally, the material property is refractive index.

Optionally, the material property is retardation (i.e. optical retardation).

Optionally, the material property is birefringence.

Optionally, the controlling includes varying the relative speed of a print head and the surface on which the layer of material is deposited. This may vary an extensional force and/or strain and/or strain rate applied to the material.

Optionally, the controlling includes varying the rate at which material is fed to a print head. This may vary an extensional force and/or strain and/or strain rate applied to the material.

Optionally, the controlling includes varying the extrusion factor, the extrusion factor being the ratio of the length of filament extruded by a print head to the distance travelled by the print head. This may vary an extensional force and/or strain and/or strain rate applied to the material.

Optionally, the controlling comprises varying the distance between a print head and the surface on which the layer of material is deposited. This may vary an extensional force and/or strain and/or strain rate applied to the material.

Optionally, the controlling comprises varying an extensional force applied to the material to thereby vary the material property.

Optionally, the controlling comprises varying a strain rate applied to the material to thereby vary the material property.

Optionally, the controlling comprises spatially and/or temporally varying the temperature of the surface on which the material is deposited to thereby vary the material property.

Optionally, the material property is degree of crystallinity.

Optionally, the controlling comprises controlling orientation of crystallisation by controlling polymer chain alignment within the layer.

Optionally, the method comprises sequentially depositing two layers of material, and the deposition is controlled to vary the thickness of both layers

Optionally, the two layers are formed of different materials. This may allow the properties of different materials to be used together.

Optionally, the thickness of the two layers varies such that the total combined thickness of the two layers is constant along the layers. This may allow variation in physical properties whilst maintaining a uniform thickness.

Optionally, the method comprises sequentially depositing a plurality of layers of material, and the deposition is controlled to vary at least one material property along at least one layer.

Optionally, the layer of material is deposited on a sacrificial layer, the layer of material having a thickness of 200 microns or less, wherein the sacrificial layer is located on a base surface.

Optionally, the method comprises forming a photonic device.

Optionally, the method comprises forming a cardiac stent.

According to the present disclosure, there is also provided a photonic device comprising one or more layers of polymeric material, wherein at least one material property varies within at least one layer. The at least one layer may be produced using additive manufacturing.

According to the present disclosure, there is also provided a cardiac stent comprising a plurality of elongate struts, wherein at least one strut comprises at least one layer, and wherein at least one material property varies within the layer. The at least one layer may be produced using additive manufacturing.

Optionally, the stent is formed of a polymeric material.

According to the present disclosure, there is also provided a method of additive layer manufacturing comprising depositing at least one layer of material on a sacrificial layer, the layer of material having a thickness of 400 microns or less, wherein the sacrificial layer is located on a base surface. This may allow parts with small thicknesses to be printed without damaging the part when it is removed from the surface on which it is printed.

Optionally, the method further comprises removing the sacrificial layer and the layer of material from the base surface.

Optionally, the method further comprises removing the sacrificial layer from the layer of material.

Optionally, the depositing of the sacrificial layer provides a level surface for the deposition of subsequent layers.

Optionally, the method includes depositing the sacrificial layer on the base surface before depositing the layer of material.

Optionally, the same apparatus is used to deposit the sacrificial layer and the layer of material. This may allow for the effect of inconsistencies in the base surface to be reduced or eliminated.

Optionally, the further comprises applying a pattern to the surface of the sacrificial layer before depositing the layer of material on the sacrificial layer. This may allow fine control over the surface properties of the printed part.

Optionally, the method further comprises controlling the deposition of the sacrificial layer to vary its thickness.

Optionally, the method further comprises controlling the deposition to vary at least one material property of the material along the layer.

Optionally, the additive layer manufacturing is fused filament fabrication.

According to the present disclosure, there is also provided an object obtainable by the methods described above.

Optionally, the object is a cardiac stent.

Optionally, the object is a photonic device.

Optionally, the object contains hidden information represented by the change in material property.

Optionally, the object is a physical unclonable function.

Optionally, the hidden information is an image.

Optionally, the material property is refractive index and/or birefringence.

Optionally, the image is a colour image.

Optionally, the image is a black and white image.

### BRIEF DESCRIPTION OF THE DRAWINGS

The present invention will now be described, by way of non-limitative example only, with reference to the accompanying drawings, in which:

FIG. 1 shows a schematic diagram of a first method according to the present invention;

FIG. 2 shows a schematic diagram of a second method according to the present invention;

FIG. 3 shows a third schematic diagram of a third method according to the present invention;

FIG. 4 shows a sacrificial layer and layer of material deposited on the sacrificial layer;

FIG. 5 shows the view of FIG. 4 with the sacrificial layer removed from the layer of material;

FIG. 6A shows a cross-section of our arrangement used to produce a layer of material deposited on a sacrificial layer;

FIG. 6B shows an end view of FIG. 6A;

FIG. 7A shows a schematic diagram of a multi-layered stent according to the present invention;

FIG. 7B shows a section through line A-A of FIG. 7A;

FIG. 7C shows a section through line B-B of FIG. 7A;

FIG. 8 shows a photonic device produced using the methods of the present invention;

FIG. 9A shows three objects containing hidden information illuminated by a light source;

FIG. 9B shows a top view of FIG. 9A, from the direction of the eye in FIG. 9A;

FIG. 10A shows a 3D model of a printed object;

FIG. 10B is a photograph of the printed object shown in FIG. 10A, viewed between crossed polarising filters;

FIG. 10C shows the relationship between print speed and measured retardation for the object of FIGS. 10A and 10B;

FIG. 10D shows a predicted retardation value and interference colour for each print speed;

FIG. 11A shows a schematic diagram of printing a layer onto a sloping bed;

FIG. 11B shows schematic diagram of printing a sacrificial layer and a main layer onto a sloping bed;

FIG. 12A shows a schematic diagram of printing a sacrificial layer onto a bed with surface non-uniformities;

FIG. 12B shows a schematic diagram of printing a subsequent layer onto the sacrificial layer shown in FIG. 12A;

FIG. 13A shows a photograph of an object as viewed by the naked eye and containing hidden information; and

FIG. 13B shows the object of FIG. 13A when viewed through crossed polarising filters.

### DETAILED DESCRIPTION

The present disclosure relates to a method of additive layer manufacturing. In particular, the method may include depositing a layer of material on a surface, and controlling the deposition to vary at least one of a material property of the material within the layer, and the thickness of the layer. The layer or layers of material which are deposited on the surface are used to make up (i.e. manufacture) an object.

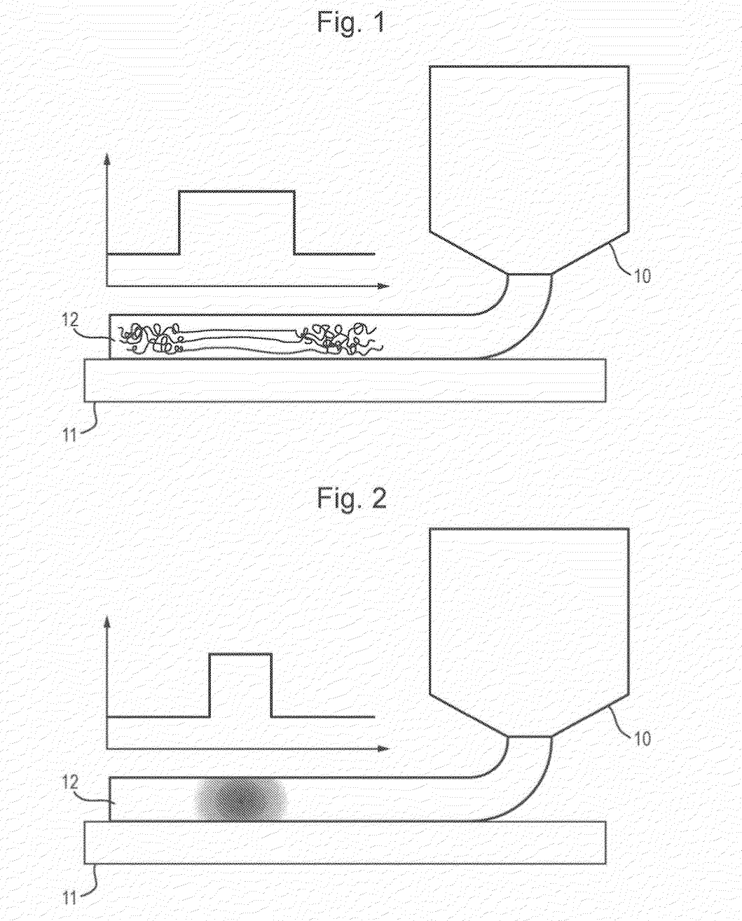

As shown in FIG. 1, a print head 10, forming part of a 3D printer, may be used to deposit the layer of material 12 on the surface 11 in order to produce an object. The material is typically a polymeric material, such as a thermoplastic material. The surface 11 on which the material is deposited is typically known as a print base, a print surface, or a print bed. It will be understood that the first layer of material when an object is being printed is deposited directly on the surface, and that subsequent layers on top of the first layer may be deposited on top of the first layer, when a multi-layered part is being produced. That is, the subsequent layers are deposited on the surface 11 with preceding layers of material therebetween.

When the material is being deposited, an extensional force is applied to the material during the deposition process. This force is due to there being a difference between the speed at which the material exits the print head (which is related to the flow rate of material being extruded), and the speed at which the print head moves across the print surface. Where the speed of the material exiting the print head is less than translating speed of the print head, the material is “underextruded”. That is, the material is stretched between leaving the nozzle and being deposited on the surface (i.e. a strain is experienced by the material).

Thus, during the deposition, the material experiences an extensional force. This extensional force results from the acceleration that the material experiences between leaving the nozzle and being deposited, due to the movement of the nozzle. In other words, the extensional force is caused by the change in velocity (i.e. acceleration) of the material being printed, from when it leaves the print head (and thus has a downward velocity relative to the print head), after which it changes both speed and direction (i.e. is accelerated) to be moving at the same horizontal velocity as the print bed relative to the print head when it is deposited. In other words, the material is accelerated so that it matches the relative horizontal velocity between the print head and the print bed during deposition. This acceleration results in a force being applied to the material. During the application of the force, the material experiences an extensional strain rate.

It will therefore be understood that the strain or extensional force or strain rate are influenced by several factors, including the speed at which the print head moves, the rate at which polymer is extruded from the nozzle, and the distance between the print head and the surface on which deposition is taking place (which, as explained above, may be a print bed, or a previously deposited layer of material).

In particular, the method may be carried out using a fused filament fabrication (FFF) 3D printer. In such a printer, a filament of material is fed to a heated print head, and the filament is extruded through the head. Such printers are commercially available, and examples of such printers include “Ultimaker” (TM) and “Prusa” (TM) printers. However, it will be understood that other FFF 3D printers, and indeed other types of 3D printer, may be used.

In general, the present disclosure relates to controlling the deposition of the layer or layers which make up the object being fabricated. This control may vary a material property of the material, with the variation being within the layer of material. That is, starting from a filament of material having substantially uniform material properties, which is fed to the heated print head, the control may create variations in the material properties of the material in the deposited layer. In other arrangements, the control may vary the thickness (i.e. the direction perpendicular to the plane of the surface on which the material is deposited) of the layer.

In other words, the variation of the material property within the layer and/or the thickness of the layer itself is actively controlled during deposition of a single layer. As will be described below, this may provide a number of advantages.

It will be appreciated that varying of material properties within a single layer (i.e. intra-layer variation), and actively controlling such a variation within a single layer, is distinct from known arrangements in which objects are printed with layers which have different properties from each other (i.e. inter-layer variation), but the property within each layer does not vary. Of course, variation of a material property within a single layer of an object does not preclude multi-layered objects being produced, with variations both within individual layers and between layers. In other words, the methods and objects of the present disclosure may include inter-layer variation of material properties in addition to intra-layer variation. Indeed, variation of material properties between layers, as well as within layers, may provide for yet further improved control over the properties of the resulting object.

It will be understood that material property may refer to bulk physical properties of the material being deposited, such as yield strength, Young’s modulus, and fracture toughness. It may also refer to material properties which are not intrinsic bulk properties of the material, such as crystallinity and polymer chain alignment (i.e. molecular alignment). It may also refer to other material properties, such as optical properties (including refractive index, retardation and birefringence), electrical properties, and other properties including degradation rate, strain at failure, strain at break, layer adhesion, and flexural strength.

In a first arrangement, the extensional force and/or strain and/or strain rate to which the material is subjected during deposition, as described above, is controlled in order to vary (and thus control the variation of) a material property of the layer 12, as shown schematically in FIG. 1. In particular, polymer chain alignment of the material which is being deposited is controlled by varying the extensional force or strain rate.

During deposition, the strain experienced by the deposited material is accommodated by the deposited material to ensure continuous deposition. Strain may be accommodated through the sliding of polymer chains relative to one another, and/or the straightening of polymer chains. It will be understood that, when the difference between the translating speed of a print head and ejection speed from the print head is greater, a greater strain is experienced by the melt. It will also be understood, that for a constant strain, an increased strain rate experienced by the material may result in chain straightening being more significant than chain sliding, as this process takes place over a shorter time interval than chain sliding.

It will be understood that, when a larger extensional force is applied (for example, by moving the print head faster), the polymer chains are “pulled” (i.e. strained and oriented) by the extensional force so as to increase the polymer chain alignment of the material. The strain and/or extensional force and/or strain rate may thus control and vary polymer chain alignment within the layer, and in turn be used to control orientation of crystallisation within the layer.

The vertical axis of the graph shown in FIG. 1 shows the speed of the print head (which in turn changes the extensional force and/or strain rate applied to the material) along the layer. The lines depicted inside the layer 12 are a schematic representation of the polymer chains in the layer. At regions where the speed (and thus the extensional force and/or strain rate) is higher, the polymer chain alignment is correspondingly higher. The change in print speed may be such that in some regions, there is little appreciable chain alignment (due to a low extensional force and/or strain rate), and that in other regions, the chain alignment is significant (due to a higher extensional force and/or strain rate).

The strain and/or extensional force and/or strain rate (and thus the chain alignment) may be varied within a single layer in a number of ways. As explained above, one significant way to vary the extensional force is to vary the relative speed of the print head 10 and the surface 11 on which the layer of material is deposited. In some arrangements, it is the speed of the print head 10 itself which is varied, but it will be understood that other arrangements which vary the relative speed between the two parts mentioned above are also possible. For instance, the surface 11 may be controlled to move, or both the print head 10 and the surface 11 may be controlled to move.

Varying the strain and/or extensional force and/or strain rate may also be achieved in a number of other ways. For example, the rate at which material is fed to a print head may be varied. This changes the amount of material ejected, or extruded, by the print head 10, and thus varies the speed of deposition of the material. Further, the ratio of the amount of material ejected by a print head (measured by the length of filament extruded) to the distance travelled by the print head may be controlled in order to vary the strain and/or extensional force and/or strain rate experienced by the melt and thus the chain alignment. This ratio is typically known as the extrusion ratio or extrusion factor. Reducing the extrusion factor decreases the speed of ejected material for a given translational speed of a translating print head with respect to the print surface. In this way, the strain experienced by deposited material is increased, because the material is “stretched” more for a given translational speed due to there being less material ejected. Likewise, reducing the extrusion factor increases the strain rate experienced by the material.

Another print parameter which can be varied (and controlled) is the layer separation. The layer separation is defined as the vertical distance moved by the nozzle between layers. This quantity is related to the distance between the print head and the surface on which deposition is taking place, but is not necessarily the same. For a correctly calibrated single layer print, or the first layer of a multi-layer print, the layer separation is the same as the distance between the print bed and the nozzle. However, for subsequent layers in a multi-layer print, the layer separation (i.e. the vertical distance moved by the nozzle between layers) is not necessarily the same as the distance between the nozzle and the layer on which deposition is taking place. This is because when a layer is deposited, it does not necessarily fill the entire height between the surface on which it is deposited and the nozzle. Thus, when the nozzle moves up between layers, the distance to the layer on which the next layer is deposited is the total of the layer separation and an offset which corresponds to the distance between the nozzle and the top of the previously deposited layer during deposition of the previous layer.

The thickness of deposited layers is also not necessarily the same as the layer separation, because the printed layer does not necessarily fill all of the distance between the nozzle and the layer on which deposition is taking place. The printed layer typically fills less than the space between the nozzle and the layer on which deposition is taking place, depending on the extrusion factor. A stable printing condition can be defined such that the thickness of a deposited layer is equal to the programmed layer separation. In multi-layer prints, there is a progression towards stable printing owing to the cumulative effects of previous layers. In such multi-layer prints where the stable condition is achieved, layer thickness is equal to layer separation. If the stable printing condition were not to be reached, the nozzle to bed distance would increase with every deposited layer until eventually failing to deposit material. This is not observed in reality for multi-layer prints and thus this stable printing condition is achieved in practice for multi-layered prints.

A change in layer separation may also result in a change in the extensional force and/or strain rate and/or strain applied to the material during deposition, because a change in the layer separation may change the acceleration to which the material is subjected between leaving the nozzle and being deposited on the surface. In particular, when the layer separation is smaller, the change in velocity of the material, from leaving the print head to being deposited, as described above, takes place over a smaller distance. This may lead to a higher acceleration and thus a larger extensional force and/or strain being applied to the material. Thus, varying the layer separation may also vary the chain alignment of the material.

As explained above, varying the strain and/or strain rate and/or extensional force applied to the polymer during deposition may in particular vary the polymer chain alignment of the material which is being deposited. In turn, variation in the chain alignment may also affect other physical properties of the material, such as mechanical properties including Young’s modulus, strain at break, extension at break, failure stress, toughness and yield stress. It may also affect, for example, optical, electrical and physical degradation properties of the material, and the crystallinity of the material.

In particular, changes in the chain alignment of the material may result in changes in the refractive index of the material. Further, the changes in chain alignment may be used to produce materials which are birefringent, and/or to control the birefringence (and thus also the optical retardation) of the material. That is, changes in polymer chain alignment may change the dependence of its refractive index on the polarization and propagation direction of light. In particular, when the chain alignment is higher, the birefringence may increase, because of the increasing anisotropy of the printed material when chain alignment increases.

As explained below, controlling this change in birefringence is useful in a number of different applications. The variation in refractive index and/or birefringence of a 3D printed object may be used to determine whether a print has been successful. For example, after printing, a printed object may be analysed for unexpected variations in refractive index and/or birefringence, which may in turn indicate flaws or errors in printing.

In one example of controlling birefringence within a layer, a sacrificial PVA layer was first printed with an extrusion factor of 0.04, a layer separation of 200 µm, a bed temperature of 55° C., and an extrusion temperature of 195° C., before a layer of PLLA (poly 1-lactic acid) was printed with an extrusion factor of 0.01, a layer separation of 50 µm and an extrusion temperature of 215° C. PLLA layers were separated from the PVA by peeling and thicknesses were measured through cross-sectional optical microscopy. Retardation values (i.e. the path difference between waves propagating along the fast and slow axis of the material) were then acquired using a Swift polarised light microscope and a Zeiss Ehringhaus compensator, according to manufacture supplied calibration curves, and the following values of birefringence (defined as retardation / sample thickness) were obtained for various print speeds:

| | | | | |
|---|---|---|---|---|
| Print Speed (mm/min) | 1000 | 2000 | 4000 | 6000 |
| Birefringence | 0.00031 | 0.00054 | 0.00083 | 0.00110 |

It can thus be seen that as the print speed increases, the birefringence also increases, for reasons explained above. Thus, print speed can be varied during the printing process of a single layer in order to control the variation in birefringence within a single printed layer. That is, in a single layer, birefringence can be varied within that layer along its length by varying the print speed while the layer is being printed.

It will also be understood that birefringence within a single layer can be controlled and varied by varying parameters other than print speed. As explained above, changing layer separation may change the extensional force, strain rate and strain experienced by the material, which may result in a change in chain alignment of the resulting material. This in turn may also change the birefringence of the printed material. In particular, a smaller layer separation may result in a larger extensional force and/or strain rate being applied to the material during deposition (due to the material accelerating over a shorter time, resulting in a larger magnitude of acceleration and larger force), leading to increased chain alignment and a consequential increase in birefringence. This effect can be observed in the table below, which demonstrates the change in measured birefringence (measured as above) for single printed PLLA layers with an extrusion factor of 0.01, printed at a print speeds of 4000 mm/min and 6000 mm/min:

| | | | | |
|---|---|---|---|---|
| Layer Separation (µm) | 50 | 75 | 100 | 125 |
| Birefringence (4000 mm/min print speed) | 0.00078 | 0.00059 | 0.00052 | 0.00041 |
| Birefringence (6000 mm/min print speed) | 0.00089 | 0.00064 | 0.00054 | 0.00043 |

This illustrates that for decreasing layer separation at a constant print speed, the birefringence increases, and further illustrates the explanation above that for a constant layer separation, birefringence increases with print speed. Again, either or both of these parameters may be varied in a controlled manner in the printing of a single layer, in order to control birefringence within the layer.

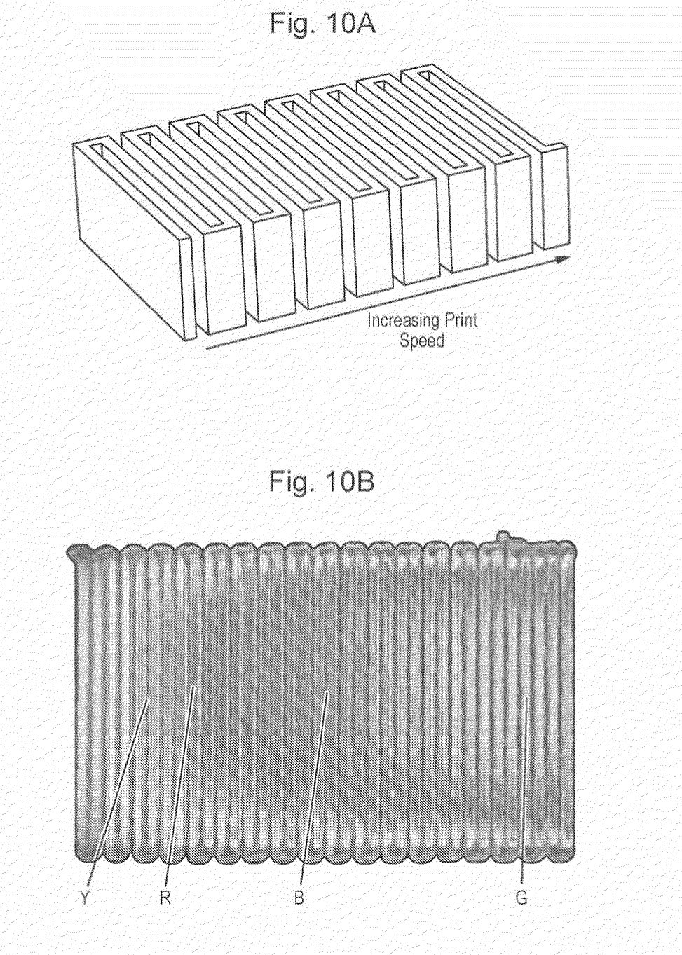

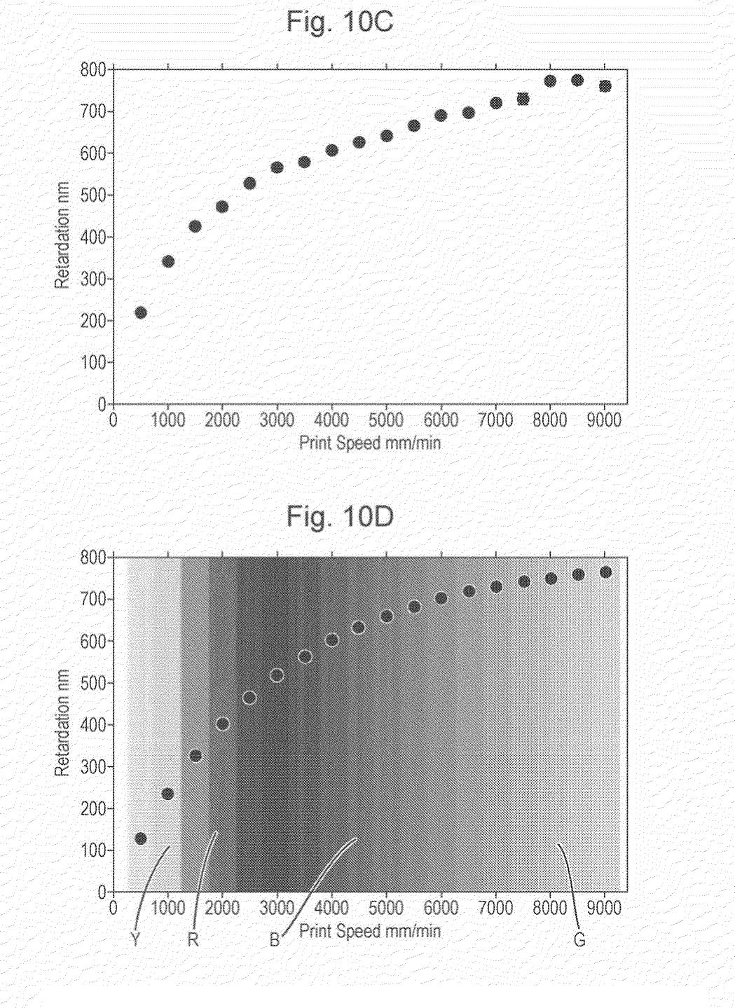

FIGS. 10A-10D illustrate an example of how a controlled variation of retardation (and thus of birefringence) can be achieved by varying print speed within individual printed layers. In particular, the variation in print speed is used to produce a portion of an interference colour chart (or Michel-Levy chart), which is used in microscopy to relate interference colours to categorise particular materials. It will be understood that this printed object is merely used as a demonstration of how retardation and birefringence can be controlled, and that objects with controlled variation of retardation and birefringence may be produced using the techniques of the present disclosure for any desired purpose. In order to aid interpretation, areas of yellow, red, blue and green colour are labelled with “Y”, “R”, “B” and “G” respectively in FIGS. 10B and 10D. It will be understood that the colours in these figures vary gradually, and that the labelled colours are merely used in order to aid identification of alike colours between the two figures.

FIG. 10A shows the physical configuration of the printed object. As shown by the arrow in FIG. 10A, the print speed was increased along the object, from left to right (with the direction of movement of the nozzle during printing being perpendicular to the arrow). The object is a 40 layer PLLA block, with each layer having a layer separation of 50 µm, and an extrusion factor of 0.01, with the print speed progressively increasing from 500 mm/min to 9000 mm/min. Each layer has an alternating aligned raster pattern, with print speed increasing between pairs of adjacent rasters such that there are two printed lines for each print speed. These layers were printed on a supporting PLLA layer with a layer separation of 200 µm, extrusion ratio of 0.04, and print speed of 1000 mm/min, and a removable sacrificial layer of PVA with a layer separation of 200 µm, extrusion ratio of 0.04, and print speed of 1000 mm/min.

FIG. 10B shows a photograph of the printed object when viewed between crossed polarising filters (with the printing direction orientated at 45 degrees to the polarisation direction), in order to illustrate the birefringence. It will be seen that the colour changes from left to right in the view shown in FIG. 10B, indicating a change in birefringence for different print speeds. It will also be noted that for each vertical line in FIG. 10B (corresponding to the direction in which the print head moves), the colour changes towards the middle of the object. This is due to the nozzle starting from, and finishing at, a stationary position for each printed line. The nozzle accelerates from rest to its nominal print speed along the vertical line, thus causing a change in birefringence in the vertical direction, corresponding to the change in colour in the vertical direction. This provides another illustration of the ability to control a variation in birefringence along a single printed raster by variation of the print speed.

FIG. 10C shows the relationship between the print speed of each line in the object of FIGS. 10A and 10B and the measured retardation for each print speed. It will be seen that as print speed increases, retardation (and thus birefringence) increases. It will be noted that as print speed increases, retardation does not increase indefinitely, and tends towards a maximum value. This is because, as explained above, the increase in retardation results from an increase in molecular (i.e. polymer chain) alignment due to the higher print speed. However, higher values of polymer chain alignment become progressively more difficult to achieve, which results in the increase in birefringence at higher increments of print speed becoming smaller.

FIG. 10D illustrates the predicted retardation and interference colour (which corresponds to the colours of a portion of a computed Michel-Levy chart) for each print speed. From comparing FIGS. 10B, 10C and 10D, it can be seen that the measured retardation closely matches the expected values, and that the colours in the finished object correspond to the predicted colours (and match the colours of the Michel-Levy chart.

In a second arrangement, and as shown in FIG. 2, the local temperature of the surface on which the material is deposited is controlled in order to vary (and control the variation of) a material property of the layer 12 within the layer. That is, the temperature of certain parts of the print bed is controlled in order to provide a variation in material property within a single printed layer.

In some arrangements, the temperature may be varied spatially on the surface on which the material is deposited. In other words, different regions of the surface can be controlled to have different temperatures, and vary locally, to thereby modify a material property within a single layer. This may be achieved by, for example, providing wires in the base surface, which may have a current selectively passed through them to cause all or some of the wires to heat up, as required, and thus vary the temperature of the base. The temperature may also vary temporally as well as spatially. It will be understood that the variation in temperature may affect not only the layer which is printed directly onto the base surface, but may also affect subsequent layers.

In particular, changes in the temperature of the surface on which printing is taking place may result in a variation of the crystallinity of the material, thus varying the hardness and density of the deposited material. Again, this variation in crystallinity may be useful in a number of different applications. The vertical axis of the graph shown in FIG. 2 shows the temperature of the print bed along the layer. The shaded region inside the layer 12 corresponding to the region where the temperature of the print bed is higher is a schematic representation of the crystallinity of the layer. At regions where the temperature is higher, the crystallinity is correspondingly higher.

Variation in the crystallinity may also affect other physical properties of the material, such as mechanical properties including Young’s modulus, strain at break, extension at break, failure stress, toughness and yield stress. It may also affect, for example, optical (including refractive index and birefringence), electrical and physical degradation properties of the material, and the chain alignment of the material.

In a third arrangement, the thickness of the layer being deposited may be controlled during deposition of the layer. That is, the thickness of the layer may be actively varied along the layer itself, providing a local variation in thickness. It will be understood that this differs from known arrangements in which individual layers are printed with different thicknesses, but a constant thickness along each layer.

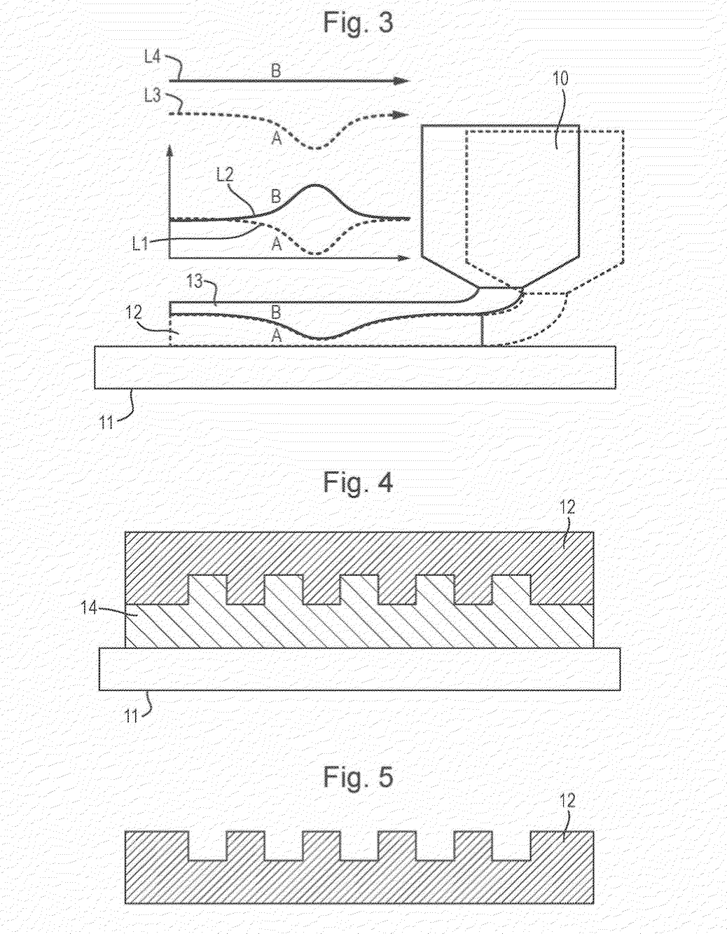

In some arrangements, the thickness of a single layer may be varied along that layer. In other arrangements, and as shown in FIG. 3, two layers of material (i.e. a first layer 12 and a second layer 13) may be deposited on top of each other, and the deposition may be controlled to vary the thickness of one or both of the layers. The thickness may be varied by controlling a number of parameters during printing, such as the extrusion factor, the distance between the print head and the surface, and/or the print speed. In this case, the interface between the two layers is at an angle to the surface on which printing is carried out, rather than being parallel to the surface (as is the case where layers with a constant thickness are being printed)

In some arrangements, and again as shown in FIG. 3, the thicknesses of the two layers 12, 13 may be varied such that the total combined thickness of the two layers is constant along the layers. In other words, in regions where the thickness of one of the layers is reduced, the thickness of the other layer is increased accordingly such that the total thickness of the two layers is constant. As discussed in more detail below, this is advantageous when a particular overall thickness is required but variation in physical properties are desired along the length of that thickness.

In the example shown in FIG. 3, the line L1 shows the extrusion factor for the first layer 12, and the line L2 shows the extrusion factor for the second layer 13. In this example, at any given point, the sum of lines L1 and L2 is the same value, although it will be understood that, in other arrangements, the sum of the lines need not be the same value and may vary.

The line L3 shows the path (in the vertical direction) of the print head when printing the first layer 12, and the line L4 shows the path (in the vertical direction) of the print head when printing the second layer 13. Thus, as shown by line L3, the print head moves down (i.e. closer to the print bed) towards the middle of printing the first layer 12. As shown by line L4, the print head stays at substantially the same height throughout the printing of the second layer 13. The print head shown in dotted line shows the position of the print head at the end of the printing of the first layer, and the print head shown in solid line shows the position of the print head at the end of the printing of the second layer.

It will be noted that the extrusion factor (i.e. the ratio of length of filament material extruded to distance travelled) is lower in the middle part of the first layer 12, and the head is moved closer to the print bed, which results in the layer being thinner in this region. Although the print head stays at the same height during the printing of the second layer 13, the relative height above the previously deposited layer will change because the height of that layer is not uniform. Moreover, the increase in extrusion factor in the middle region means that the thickness of the second layer 13 increases in this region.

It will be understood that the thickness of the layers of material being deposited may be controlled by using different combinations of parameters, including print head speed, extrusion factor, bed temperature, extrusion temperature and layer separation. Merely as an example, a layer can be made thinner in a number of ways, including increasing the print speed (with a constant feed rate) so that less material is deposited on a given area in a given time, changing the layer separation, changing the extrusion factor and changing the extrusion temperature. This may allow the physical properties of the layer (including birefringence and crystallinity) and the thickness of the layer to be controlled independently of each other.

Although the head moves in the same direction for both layers in FIG. 3 (as shown by the arrows on lines L3 and L4, it will be understood that in some arrangements, subsequent layers may be formed by the print head 10 moving in opposite directions over the print surface 11. This may result in a quicker print, because the print head 10 deposits material in both directions.

In arrangements where two layers are present, the two layers may be formed of different materials. This may allow the physical properties of the combined layer to be closely controlled. For example, a first layer of a material with high stiffness and low toughness may be used, and a second layer of material with high toughness and low stiffness may be used. In this arrangement, the thickness of the layers can be controlled such that where high stiffness is required, the high stiffness material layer is thicker, and where high toughness is required, the high toughness material layer is thicker. Merely as an example, one layer may be formed of PLLA (poly 1-lactic acid), and the other layer may be formed of a PHA (polyhydroxyalkanoate). In a preferred example, one layer may be formed of PLLA and the other layer may be formed of a mixture of PLLA and a PHA.

It will be understood that the above arrangements relating to two layers are not limited to there only being two layers, but additional layers may be provided. In other arrangements, three or more layers may be provided, with the thickness of one or more of the layers being varied by controlling the deposition as explained above.

The above arrangements relating to the thickness of layers may also be combined with varying the strain and/or extensional force and/or strain rate applied to the material, or the temperature of the surface on which the material is deposited, as explained above, in order to vary other material properties, such as chain alignment, birefringence and crystallinity, within or along the various layers. This may provide for fine, localised control over the material properties of the object being produced by the additive layer manufacturing.

In any of the above arrangements, the deposition of material is carried out by moving the print head in a given first direction relative to the surface on which the deposition is taking place. It will be understood that the variation of the material property and or the thickness within the layer may be in the first direction. That is, along the direction in which the print head moves, the material property or the thickness varies in the same direction.

In a fourth arrangement, and as shown in FIGS. 4 and 5, a layer of material 12 (i.e. the layer forming the object being printed) may be deposited onto a sacrificial layer 14 (i.e. a layer which is used during the printing process but does not form part of the object being printed). The layer of material 12 may have a thickness of 400 microns or less, and may preferably have a thickness of 200 microns or less, more preferably 100 microns or less, and yet more preferably 50 microns or less. The sacrificial layer 14 may be located on a base surface 11 (e.g. a print bed as described above). In other words, the sacrificial layer 14 is interposed between the base surface 11 and the layer of material 12.

This arrangement may allow particularly thin structures to be printed using the 3D printer. In particular, thin parts which are printed using known methods can be difficult to handle due to their very small thickness. That is, if a thin layer (such as one with a thickness of 200 microns or less) is directly deposited onto a base surface, it may be easily damaged when it is removed from the base surface. The adoption of a sacrificial layer between the layer of material and the base surface may allow the sacrificial layer 14 and the layer of material 12 (i.e. the printed part) to be removed from the base surface together, without damaging the layer of material 12. It can also have other advantages, as discussed below.

It has been found experimentally that, by printing a sacrificial layer of PVA with a layer separation of 200 µm and an extrusion factor 0.04, layers of PLLA with layer separations of 25 µm to 200 µm can be successfully printed and removed from the sacrificial layer. In particular, thicknesses of 25 µm. 50 µm, 150 µm, 175 µm, 200 µm, 225 µm, 250 µm, 275 µm and 300 µm were printed. Printing of layers of these thicknesses (and particularly towards the lower end of this range) was previously very difficult due to the difficulty of removing thin layers (which may be fragile) from the print bed. Thus, the methods of the present disclosure using a sacrificial layer allow thin layers of material to be printed and removed without damaging the material. As explained below, this may be useful in a number of applications.

The method may further comprise removing the sacrificial layer 14 from the layer of material 12. This may be done by mechanically removing the sacrificial layer (e.g. peeling the sacrificial layer away from the printed part), or by using a chemical process, such as dissolving the sacrificial layer. Such chemical processes will depend on the material used for the sacrificial layer. However, for example, a water soluble sacrificial layer 14 (e.g. formed of polyvinyl alcohol (PVA)) could be dissolved away by water provided the layer of material 12 is not water soluble.

The sacrificial layer may be formed by any suitable process, and may be of any suitable shape and cross-sectional area. However, merely as an example, when parts of 200 microns or less are being printed, the sacrificial layer may typically have a rectangular shape with rounded edges with a thickness of 100-400 microns and a width of 600-900 microns.

In some arrangements, the sacrificial layer 14 may be deposited on the base surface 11 before depositing the layer of material 12, and in particular, the same apparatus may be used to deposit the sacrificial layer and the layer of material. That is, when a 3D printer with a print head is used, the same print head and 3D printer may be used to first deposit the sacrificial layer 14 on the base surface, and then deposit the layer of material 12 to form the desired part.

Depositing the sacrificial layer using the same apparatus as the layer of material forming the part may provide a number of advantages. For example, the thickness of the sacrificial layer may be controlled during printing, in the same way as the thickness of the layers of material as described above. However, the thickness of the deposition need not be actively controlled, and may change passively as a result of the material of the sacrificial layer “filling” any extra space caused by, for example, a slope or non-uniformity of the base.

Variations in thickness of the sacrificial layer during application may provide a number of advantages. A slope or non-uniformity of the base surface may result in the distance between the base surface and the print head not being constant, which may result in an uneven print. When a very thin part is being printed, a very small slope or non-uniformity of the base surface may have a disproportionately large influence on the print, because the base surface is typically large relative to the thickness of the layer(s) being printed.

However, if the sacrificial layer is first printed using the same device with which the layer of material forming the part will be printed, the effect of such changes can be avoided.

Thus, in some arrangements, the printing of the sacrificial layer may “level out” the base surface, because the sacrificial layer can passively compensate for variations in the base surface, due to it filling the space available. For the same reasons as above, this may be particularly advantageous when thin layers (e.g. layers less than 400 microns thick, as described above) are being printed.

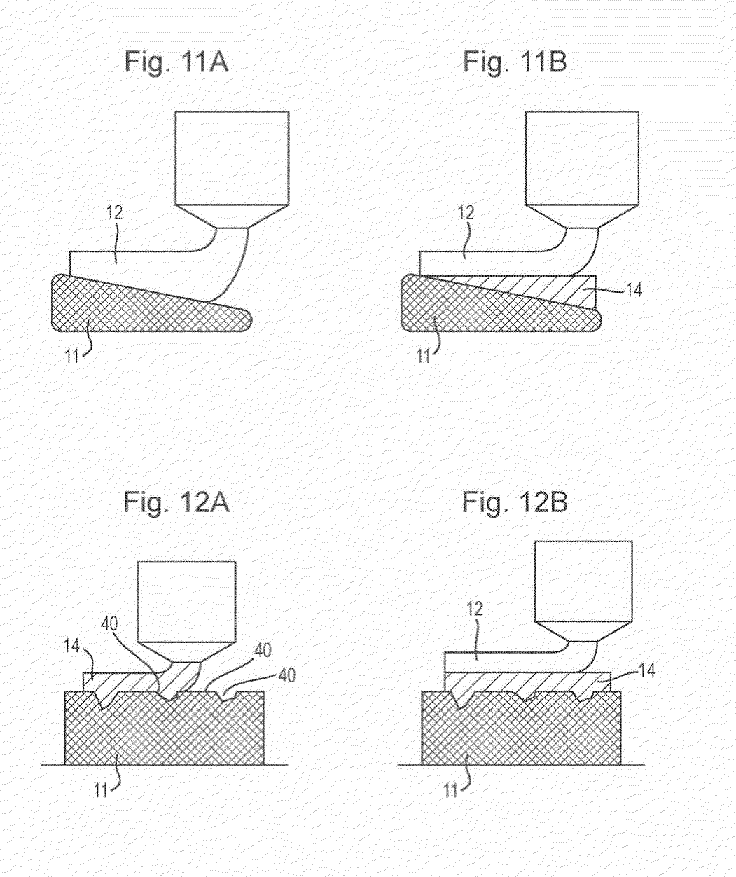

Schematic illustrations of such a “levelling out” occurring passively is shown in FIGS. 11A, 11B, 12A and 12B. It will be understood that the relative dimensions, sizes, shapes and angles shown in these figures are merely schematic and for the purpose of illustrating the concepts. In practice, the angles and variations described may be much smaller than those shown in these figures.

In FIG. 11A, an illustration of printing a layer 12 directly on to a sloping bed 11 (i.e. base surface) is shown. It can be seen that the thickness of the printed layer varies due to the slope of the bed. On the other hand, in FIG. 11B, a sacrificial layer 14 is first printed onto the bed 11, and then a (non-sacrificial or main) layer 12 is printed on top of the sacrificial layer 14. Because the upper surface of the sacrificial layer is level, the main layer is printed on a level surface, which results in the thickness of the main layer being uniform.

As explained above, FIGS. 11A and 11B are merely schematic. In practice, a bed which is intended to be level may have a slight slope (i.e. less than the angle shown in FIGS. 11A and 11B) due to, for example, miscalibration or movement. However, even a slight slope may have a disproportionately large impact when very thin layers are being printed (as described above). Thus, the use of a sacrificial layer may allow for improved consistency and control over the thickness of very thin subsequent layers which are printed, by negating the effects of sloping beds (or base surfaces).

Likewise, the use of a sacrificial layer may compensate for non-uniformities in the base surface (i.e. the print bed), such as scratches or dents. This is schematically shown in FIGS. 12A and 12B, where a number of indentations 40 are shown in the base surface 11 are present. A sacrificial layer 14 is printed, which fills the indentations whilst providing a level surface on which subsequent layers 12 can be printed. In practice, the indentations or non-uniformities may be due to damage or wear to the print bed, due to manufacturing defects or due to the properties of the material from which the bed is formed.

Thus, the use of a sacrificial layer can extend the lifespan of print beds in heavy use, or reduce the manufacturing tolerances of bed levelness and smoothness, whilst still maintaining good surface finish and uniform thickness on printed parts. Again, this may be of particular importance where very thin parts, as described above, are being printed. In practice, the non-uniformities may be small relative to the size of the print bed (and may not be visible to the naked eye), but nonetheless have a disproportionately large effect on the layers 12 which are printed if those layers are very thin. Thus, again, the use of a sacrificial layer may allow for improved consistency and control over the thickness of very thin subsequent layers which are printed, by compensating for inconsistencies or non-uniformities in the base surface.

Further still, the use of a sacrificial layer may allow consistency between printers, or between print runs, regardless of whether the print bed is level or not. For example, two different printing machines may be used to produce the same part. Without the use of a sacrificial layer, if the two machines are not calibrated in exactly the same way, there may be a variation between the finished parts produced by the two machines. Likewise, a similar variation may arise between print runs on the same machine, especially if the machine has been recalibrated between runs. Again, this effect may be particularly noticeable if the parts being printed are very thin, due to a small absolute variation having a disproportionately large effect relative to the thickness of the part. However, if a sacrificial layer is first printed, and the main layer(s) of material printed on to the sacrificial layer, the exact distance from the surface on which printing is takes place is known (because that surface has been deposited as a sacrificial layer), thus avoiding or reducing calibration errors. In other words, the sacrificial layer acts as a datum surface onto which the deposition of the main layers takes place, and the height of the nozzle for subsequent layers can be accurately controlled. Thus, the use of sacrificial layers may negate variations between different printers, or between different runs of the same printer.

In some arrangements, a pattern can be applied to the sacrificial layer 14 before depositing the layer of material on the sacrificial layer. This may provide a number of advantages. In particular, a very small-scale pattern can be produced on the sacrificial layer, which is then imparted by the sacrificial layer onto the part being printed. This is shown as a stepped pattern in FIGS. 4 and 5. Of course, it will be understood that the stepped pattern shown in FIGS. 4 and 5 is merely schematic, and that the pattern may be much smaller than the scale of the parts being printed, and may be of any particular form. In some examples, the pattern may have a texture such that it is arranged to control or guide cell attachment, which may be advantageous when the printed material is used in medical devices, such as (but not limited to) the stents as described below.

It will be understood that the above arrangements relating to a sacrificial layer may be combined with one or more of the other arrangements described above. For example, as well as printing on a sacrificial layer, the deposition may be controlled so as to vary the thickness of one or more of the layers of material being deposited on the sacrificial layer. Further, the deposition of any of the layers may be controlled so as to vary at least one property of the material along the layer, in any of the ways described above.

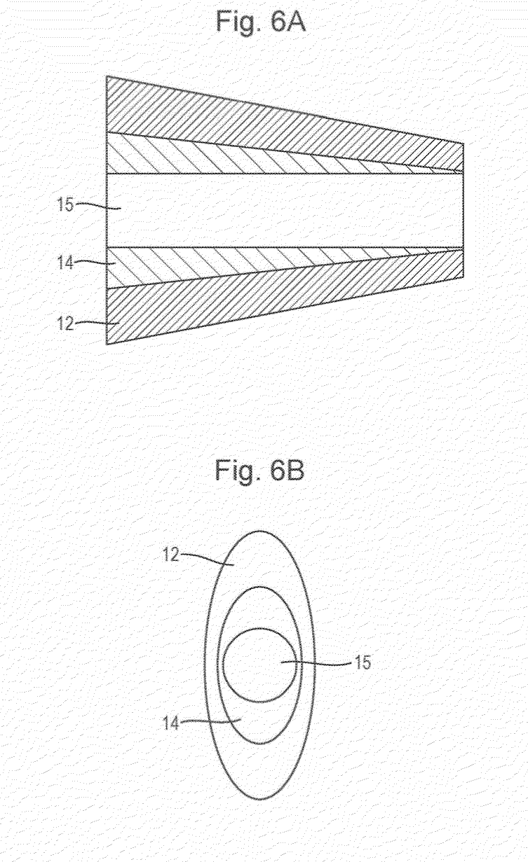

In some arrangements, and as shown in FIGS. 6a and 6b, the sacrificial layer 14 and the layer of material 12 forming the part being printed may be printed onto a rotating drum (or mandrel) 15. This may result in a generally tubular part being printed. As shown in FIG. 6a, the thickness of the sacrificial layer 14 may be varied so that a part with a varying cross-section can be produced, even when the rotating drum 15 onto which printing is taking place has a uniform cross-section. Thus, the use of a sacrificial layer may allow variation of the shape being printed regardless of the surface onto which printing is taking place. The shape of the drum itself may alternatively or additionally be varied in order to provide a variation in shape (e.g. cross-section) of the part being printed. As described above in relation to sacrificial layers, the use (and subsequent removal of) a sacrificial layer on a drum may allow a tubular part to be removed from the drum without being damaged.

The methods above, and combinations thereof, may be used in order to produce many different objects. Some particular objects which may be advantageously produced by these processes will be described below. However, it will be understood that the objects produced by these processes are not limited thereto.

In particular, the methods described above may be particularly useful for producing cardiac stents. That is, any of the methods described above may be used to form a cardiac stent. Such cardiac stents are typically used in the treatment of coronary artery disease (CAD). CAD is caused by the narrowing of coronary arteries through the build-up of plaque on arterial walls, restricting the supply of blood to the heart. Surgical treatment of CAD typically involves the placement of a stent within an afflicted artery in order to open its lumen and restore blood flow.

Conventional stents are typically made from a combination of metal and drug-eluting polymers, and are designed to remain permanently in position. A stent is crimped onto an inflatable balloon, which may be delivered to the target area by feeding through an artery in the arm, or in the groin. Once in position, the balloon may be inflated, which forces the stent to permanently expand, thus widening the damaged artery. The balloon is subsequently removed and normal blood flow is restored.

Stent performance is often assessed based on the ability to hold an artery open and to avoid restenosis (the recurrence of abnormal narrowing of the target artery). Hence stents must be sufficiently stiff to resist arterial contraction and exhibit minimal elastic recoil once the balloon is removed. Significant recoil is undesirable as this would necessitate over-expansion of the damaged blood vessel when expanding the stent to compensate for the subsequent contraction (i.e. recoil) of the stent, risking perforation of the vessel. Further recoil of the stent over time may also lead to restenosis, leading to re-obstruction of the vessel. Additionally, fracture of stents during or post implantation can lead to a significant reduction in mechanical performance, as well as increasing the chance of restenosis and strokes.

Further, stent thickness shows strong correlation with restenosis rates, with thinner stents displaying better clinical performance; a thickness of less than 140 microns is typically used. Whilst the risk of restenosis is significantly reduced 6 months after implantation, conventional metallic stents remain in the body indefinitely, which may lead to the stiffening of the arterial wall and the site of the stent becoming inflamed. To address these issues, bioresorbable stents (BRS) have been developed with degradation times of approximately two years. Out of the range of biodegradable materials available, polymers have been selected to meet the required mechanical and degradation properties of BRS. In particular, BRS have been made from polylactic acid (PLLA).

However, clinical performance of bioresorbable stents has not been uniformly successful, with increased incidences of restenosis and strokes observed in patients. Bioresorbable stents typically have a thickness larger than the 140 microns referred to above. This highlights one of the main complications of polymer-based stents rather than conventional metal-based stents; namely that polymer processing differs from metal processing. Polymer stents are typically fabricated by laser machining, which may lead to thermal gradients during fabrication, which in turn may lead to anisotropy in mechanical and degradation properties through uncontrolled variation in polymer crystallinity. Such an uncontrolled variation may be reduced by using high repetition rate lasers with short pulses (e.g. femtosecond lasers) to cut out parts of the stent with undesired properties. However, such devices are typically large and very expensive. There is a need to control the properties of polymer stents in a more convenient and cost-effective way. The material characteristics that lead to sufficient stiffness in polymer stents (to hold an artery open) may lead to an increase in the likelihood of brittle failure, and stent fracture. In contrast, tougher polymers with lower moduli reduce the risk of brittle failure but are limited by elastic recoil across the whole stent.

Stents produced using the methods of the present disclosure may address these problems by the variation of material properties or thickness within a layer. In particular, the stent may be printed using a polymeric material by any one (or combination) of the methods described above, which allows the properties of the polymer material to be controlled on a fine scale. This means that various parts of the stent can be designed to have high stiffness where required, and high toughness in other locations where required. For example, the parts where the stent is designed to deform (for example at “hinge” regions of the stent about which the elongate parts of the struts move) may have a low stiffness in order to allow deformation, and the parts which typically recoil after expansion (such as the elongate parts of the strut) may have a high stiffness in order to reduce undesirable elastic recoil. This may be achieved by the variation of material properties within layers as described above.

A further advantage of stents produced using the methods of the present disclosure is that the control of chain alignment of the polymer may allow the properties of the stent to be improved. That is, the orientation of the polymer chains is in the print direction, which in turn is along the length direction of the individual struts making up the stent. This direction is also the direction in which forces are applied to the stent. On the other hand, for conventional polymer stents, a polymer tube is extruded and laser cut to form the stent. In this situation, the orientation of the chains is along the axis of the tube. When parts are cut out using a laser, the remaining struts are not parallel to the axis of the tube, and thus the polymer orientation is not along the struts.

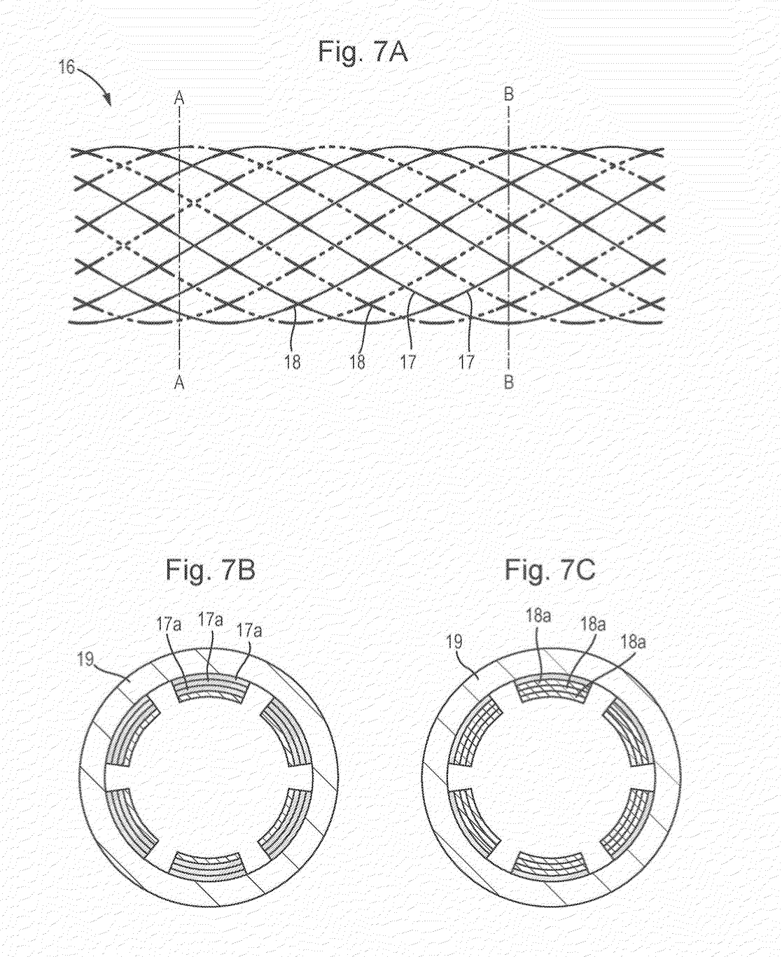

FIGS. 7A, 7B and 7C show an example of a stent 16 produced using the methods of the present disclosure. The stent is formed of a number of elongate struts 17, which join together at hinge regions 18. The elongate struts and hinge regions may be printed together in a continuous structure. Each strut is formed of a plurality of layers, as shown in the cross-sections of FIGS. 7B and 7C. FIGS. 7B and 7C also show the stent positioned inside a blood vessel 19. In FIGS. 7B and 7C, the light coloured layers indicate a material with high toughness and low stiffness, and the dark coloured layers indicate a material with high stiffness and low toughness.

The section (through line A-A of FIG. 7A) shown in FIG. 7B is taken at a location partway along the struts, where the stent is formed of a stiff material. This is achieved by varying the material properties within each layer during printing such that the majority of the layers 17a (in this example, all but the innermost layer) making up this part of the stent are formed of a high stiffness material, using the methods described above. Thus, undesired elastic deformation can be reduced.

The section (through line B-B of FIG. 7A) shown in FIG. 7C, on the other hand, is taken at a location where a hinge region is located, where the stent is formed of a tougher, but less stiff material. This is achieved by varying the material properties within each layer during printing such that the majority of the layers 18a (in this example, all but the outermost layer) making up this part of the stent are formed of a more compliant (i.e. lower stiffness) but higher toughness, using the methods described above. Thus, the stent can deform as much as required in the hinge regions, whilst reducing undesired deformation in other regions.

As described above, the methods of the present disclosure may also allow for very thin layers to be printed, without the layers being damaged when removed from the print bed. This may be particularly advantageous when printing cardiac stents, because as explained above, stents are normally formed of thin struts (with a thickness which is typically of the order of 140 microns). It will be understood that a strut forming part of the stent may be formed of a single printed layer, with a material property and/or the thickness of the layer varying along the strut, or may be formed of multiple layers. When multiple layers are used, the variation in material property and/or the thickness may be in only one of the layers, or in more than one of the layers, or in all of the layers.

Further, the methods of the present disclosure may allow stents to be “personalised”. That is, a scan may be taken of a patient’s blood vessel, and the shape of the stent (including the variation in material properties and/or thickness) may be designed to meet the requirements of the patient’s particular blood vessel shape. The stent may be printed on to a rotating drum, as described above, in order to produce an appropriate shape. As described above in relation to parts printed on rotating drums in general, the shape of the drum itself may also be changed in order to vary the shape of the stent.

The detection of flaws or errors in printing by detecting changes in birefringence of the finished print, as described above, may be particularly useful for “personalised” stents, where the particular design being used has not been previously printed.

Stents produced according to methods of the present disclosure may also be designed to degrade in a certain manner so as to reduce the risk of parts undergoing degradation causing damage to the patient. In other words, the material properties of various parts of the stent may be controlled so that when undergoing degradation (or if the stent is damaged), the stent breaks into small parts, in a similar manner to the breaking of safety glass, which can easily be resorbed.

The methods of the present disclosure may also be advantageously used to produce photonic devices, including (but not limited to) wave guides, ring resonators and optical couplers.

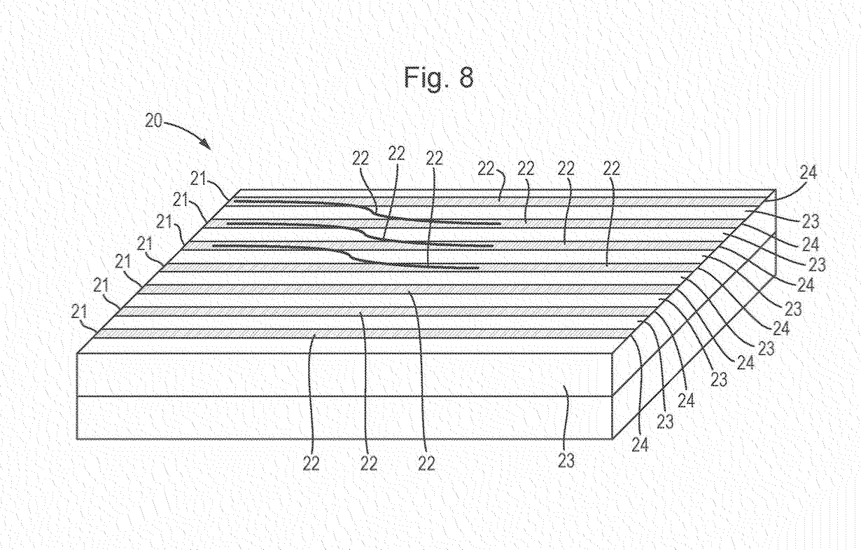

In particular, and as shown in FIG. 8, the variation in material properties (such as refractive index and/or birefringence, as explained above) within layers may lead to variations in the light transmitting properties of various parts of a photonic device 20, and this variation can be controlled on a small scale using the methods of the present disclosure. That is, the variation in material properties and/or thickness can be used in order to guide light through a photonic device. In particular, the layers may be polymeric layers. As shown in FIG. 8, the device may have a number of different layers and regions, and the properties (including refractive index) of the layers may be controlled as described above to either permit, block or modify the passage of light therethrough. It will be understood that modifying the passage of light may include, but is not limited to, changing the phase or polarisation of the light, reflecting the light, refracting the light, diffracting the light or changing the speed of propagation of the light.

In particular, the device 20 may include one or more inputs 21 into which light can be introduced, one or more guide regions or passages 22 (shown in darker shading) through which light is guided , and one or more outputs 24 through which light can leave the device. All of the inputs, passages and outputs are formed so that light can pass through them. The device also includes non-guide regions 23 (shown in lighter shading) through which light is not guided. It will be understood that the non-guide regions may be light blocking regions which do not allow light to pass through, or may be regions through which light may still propagate, but is not preferentially guided to these regions. Thus, light is guided through the device by the inputs, passages and outputs. It will be understood that the inputs, passages and outputs and the light-blocking regions may be formed in a single 3D printed layer, with the optical properties of the layer varying within the layer, as described above. Alternatively, the various parts of the device may be formed in different layers.

The production of such photonic devices using the methods of the present disclosure may allow devices to be quickly and cheaply produced using 3D printing, and allow devices to be quickly redesigned and customised, whilst retaining fine control over the function of the photonic device because of the variation within layers.

In yet another application, the methods of the present disclosure may be used to produce objects which contain hidden information represented by the change in material property. This is a form of steganography. In particular, changes in material property, such a birefringence as described above, may be used to produce an object which has information “coded” into (or hidden in) the object. The hidden information may be detected by any suitable means. For example, the information may only be detectable through a particular set of filters. Alternatively, a spectrum analyser, or any other arrangement for detecting changes in a property of light, may be used to detect the hidden information. In the case of birefringence, the birefringence may be observed, for example, by placing the material between crossed polarising filters.

The information hidden in the object may be of any form, including images, bar codes, single bits of data or any other information. It will also be understood that the light used to detect such information (using crossed polarising filters or spectrum analyses) need not be in the visible spectrum. In the case of an image, the image may be a colour image or a black and white image. It will be understood that an “image” or other “hidden information” need not be viewable using visible light, but may also be “viewed” or accessed using detectors for light outside of visible wavelengths.

For example, certain layers of a printed object may have regions which were printed with a first stain and/or extensional force and/or strain rate, and other regions which were printed with a second (different) strain and/or extensional force and/or strain rate. When these regions are viewed through cross-polarized filters, they may have different colours due to a variation in birefringence (as explained above). This principle can be used to conceal information (e.g. an image or other information as described above) within the layer, which is only detectable (and in the case of visible light, visible) when the correct filters are used.

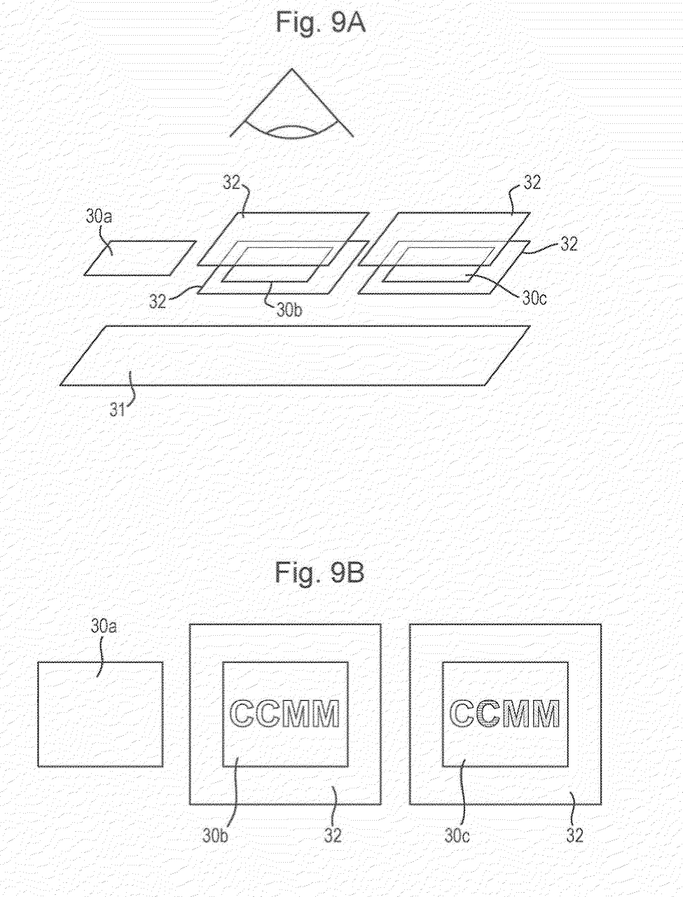

FIGS. 9A and 9B show an example of an object with information hidden in using variation in birefringence. FIG. 9A shows a perspective view of three such steganographic objects 30a, 30b, 30c, placed in front of a light source 31, of which the first 30a is not placed between crossed polarising filters 32, and the second and third 30b, 30c are placed between crossed polarising filters 32. When viewed in the plan view of FIG. 9B (i.e. as viewed by the eye schematically shown in FIG. 9A, the objects 30a, 30b, 30c are illuminated from below by the light source 31. It can be seen that no pattern is visible (i.e. the object appears to be a solid colour) when not placed between the crossed polarising filters, because the hidden information (i.e. the letters “CCMM”) is defined by changes in birefringence, which are not typically visible to the naked eye.

However, when the objects 30b and 30c are placed between crossed polarising filters 32, the pattern of letters “CCMM” (which is an example of the information which can be hidden) is visible. This is because the polarisation state of the light which passes through the bottom filter (i.e. the filter between the light source and the object) is altered by the introduction of varying degrees of retardation by the birefringent parts of the material, allowing certain wavelengths of light to pass through the upper filter. The areas of the object which do not have a birefringent property appear dark, because the polarised light which passes through the bottom filter cannot pass through the second filter, which is orientated at 90 degrees to the polarisation state of the light.

It will be understood that any information, including letters as shown in FIGS. 9A or 9B, or an image such as an image of another object, can be hidden in the objects described above. Further, the birefringence of different parts within a layer (or multiple layers) of the object may be adjusted using the methods of the present disclosure such that light of different wavelengths can pass through the filters, thus providing a colour image as in object 30c. Alternatively, a black and white image may be provided by only allowing a single wavelength (or combination of wavelengths) of light to pass, as in object 30b.

Fine control over printing parameters, such as print speed, may result in fine control over an image hidden in an object. In particular, the birefringence within a layer may be varied by varying print speed (as explained above) in order to provide a colour variation in the hidden image when the object is viewed between crossed polarising filters.

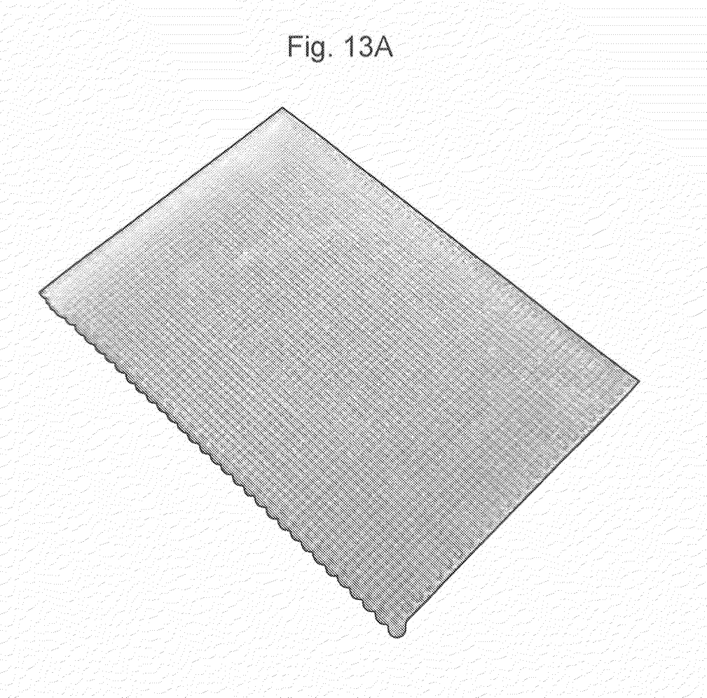

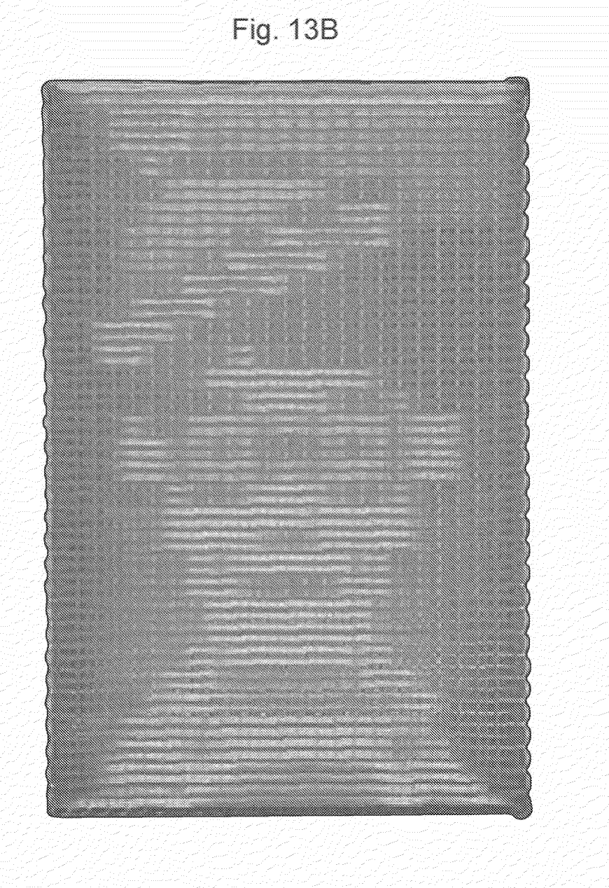

An example of such an object is shown in FIGS. 13A and 13B, where a colour image of a cartoon character has been produced (hidden in the object) by varying print speeds within layers of printed material. FIG. 13A shows the object as visible to the naked eye. The image cannot be seen in this figure. FIG. 13B shows the object when placed between crossed polarising filters, which reveals the colour image. The fine control over the colours in an image (which can be broken down into pixels) may allow a large amount of information to be stored in the image. That is, rather than using black and white images (where each pixel can be considered to have a value of 0 or 1 for the purposes of storing information), each pixel can be “coded” to have a range of values, with the value being indicated by the controlled birefringence of the printed pixel. FIGS. 13A and 13B provide an example of the use of five different colours. However, it will be understood that with the use of measuring equipment rather than the human eye, much smaller changes in birefringence can be detected, so that an individual pixel could be varied to have many more possible values. This may allow a large amount of information to be “coded” in a hidden way into the image.

In order to produce this image, a removable bed-levelling sacrificial PVA layer was first deposited, with a layer separation of 200 µm, and extrusion factor of 0.04 and a print speed of 1000 mm/min, followed by a supporting PLLA layer with a layer separation of 200 µm, an extrusion factor of 0.04 and a print speed of 1000 mm/min. The image was then formed by varying print speed, resulting in changes in retardation and birefringence by spatially varying print speed within individual layers of a 40 layer PLLA block with an alternating raster pattern, a layer separation of 50 µm and an extrusion factor of 0.01.

In the PLLA layers forming the image, the print speed was varied between 500 mm/min and 6000 mm/min in order to produce colour variations within layers. In particular, speeds of 500, 750, 1000, 2000 and 6000 mm/min were used to produce black, gray, white, skin tone and red respectively. The printing direction is from the horizontal direction (i.e. left to right and right to left) in the orientation shown in FIG. 13B, so where the colour varies along a horizontal line in the image, this is the result of print speed varying along the respective printed layer, resulting in a variation in birefringence within that layer.

Such objects may be particularly useful in many fields including, for example, encryption, cryptography, and anti-counterfeiting. Applying the techniques of the present disclosure to these fields may have several benefits. It may allow the production of objects with hidden information (such as access tokens) on site, and in the full control of the verifier. This means that the verifier is in complete control of both the manufacture and verification of the object, thus providing increased security compared to the use of, for example, access tokens produced by third parties. For example, government agencies may be wary of access tokens produced in foreign countries. Further, the production of access tokens (or other such objects) in this way may allow the verifier to alter designs quickly, to limit the number of people with knowledge of their function, and allow the quick issuing of access tokens, for example in printing new access cards for a department.

A further possible application of objects printed with a controlled variation in birefringence within single layers (or using other techniques as described above) is the productions of physical unclonable functions (PUFs), which can also be considered to be a type of authentication token. In particular, a physical unclonable function (PUF) is an object that provides a unique identification based on inherent differences in a manufacturing process. For a given input (challenge) the PUF returns a unique output (response) that identifies the object. Thus, the PUF can be verified based on its inherent properties associated with the manufacturing process, and cannot be copied by third parties.

The techniques of the present disclosure, and in particular (but not limited to) the control of birefringence within printed layers, may be used in the production of PUFs. When objects are printed with a controlled variation in a materials property within a layer in accordance with the present disclosure, additional variations will also typically be present, detectable at smaller scales than the controlled variation. For example, when birefringence is controlled to be a particular nominal value in accordance with the methods above, there is also a (much smaller) variation in birefringence from the nominal value, associated with, for example, the specific feedstock material used, the type and model of printer, and printing conditions. In this example, both the (actively) controlled induced birefringence and smaller variations of this inherent to specific feedstock materials, printers, printing conditions, print-to-print variations, can be used as a unique identifier, with the smaller scale variations acting as a PUF. In other words, a third party would not be able to reproduce the specific, smaller scale birefringence variation within a new print to achieve the same exact transmitted (and detected) spectrum from an object, even if they can reproduce the overall controlled variation in birefringence.

In particular, an input challenge (spectrum of light) is modified by regions of printed polymer (function) in with variable birefringence, resulting in a modified output response (a modified spectrum of light) that can be verified. It has previously been postulated (in WO2015/077471) that PUFs may be produced using 3D printing. However, this document describes a device with a separate printed matrix and detectable elements (with the detectable elements responsible for generating the PUF). Using the techniques of the present disclosure, the PUF is formed by the properties of the printed matrix itself (i.e. by detectable variation in characteristics of the birefringence within printed layers).

The methods of the present disclosure may also be useful in producing other objects, such as those which have fast development cycles and thus benefit from rapid prototyping, as well as for parts which benefit for marking and/or labelling, which may be achieved by incorporating hidden information as described above. The methods of the present disclosure may also be beneficial in the production of “lab on a chip” devices, or in medical devices other than stents, such as other types of implants, where the variation in properties can be used to produce instrumented implants with, for example, integrated light couplers, using the controlled variation in refractive index as described above.

It should be understood by those skilled in the art that while the present invention has been described with reference to exemplary embodiments, it is not limited to the disclosed exemplary embodiments. Various modifications, combinations, sub-combinations and alterations may occur depending on design requirements and other factors insofar as they are within the scope of the appended claims or the equivalents thereof. Features from any example or embodiment of the present disclosure can be combined with features from any other example or embodiment of the present disclosure.

1. A method of additive layer manufacturing comprising:
depositing a layer of a material on a surface; and
controlling the deposition to vary a material property of the material within the layer.

2. The method according to claim 1, wherein the depositing is carried out by moving a print head in a first direction relative to the surface, and the variation of the material property is along the layer in the first direction.

3. The method according to claim 1 or 2, wherein the material property is polymer chain alignment.

4. The method according to any preceding claim, wherein the material property is refractive index.

5. The method according to any preceding claims, wherein the material property is retardation.

6. The method according to any preceding claim, wherein the material property is birefringence.

7. The method according to any preceding claim, wherein the controlling includes varying the relative speed of a print head and the surface on which the layer of material is deposited.

8. The method according to any preceding claim, wherein the controlling includes varying the rate at which material is fed to a print head.

9. The method according to any preceding claim, wherein the controlling includes varying the extrusion factor, the extrusion factor being the ratio of the length of filament extruded by a print head to the distance travelled by the print head.

10. The method according to any preceding claim, wherein the controlling comprises varying the distance between a print head and the surface on which the layer of material is deposited.

11. The method according to any preceding claim, wherein the controlling comprises varying an extensional force applied to the material to thereby vary the material property.

12. The method according to any preceding claim, wherein the controlling comprises varying a strain rate applied to the material to thereby vary the material property.

13. The method according to any preceding claim, wherein the controlling comprises spatially and/or temporally varying the temperature of the surface on which the material is deposited to thereby vary the material property.

14. The method according to any preceding claim, wherein the material property is degree of crystallinity.

15. The method according to any preceding claim, wherein the controlling comprises controlling orientation of crystallisation by controlling polymer chain alignment within the layer.

16. The method according to any preceding claim, wherein the method comprises sequentially depositing two layers of material, and the deposition is controlled to vary the thickness of both layers.

17. The method according to claim 16, wherein the two layers are formed of different materials.

18. The method according to claim 16 or 17, wherein the thickness of the two layers varies such that the total combined thickness of the two layers is constant along the layers.

19. The method according to any preceding claim, wherein the method comprises sequentially depositing a plurality of layers of material, and the deposition is controlled to vary at least one material property along at least one layer.

20. The method according to any preceding claim, wherein the layer of material is deposited on a sacrificial layer, the layer of material having a thickness of 200 microns or less, wherein the sacrificial layer is located on a base surface.

21. The method according to any preceding claim, comprising forming a photonic device.

22. The method according to any one of claims 1-20, comprising forming a cardiac stent.

23. A photonic device comprising one or more layers of polymeric material, wherein at least one material property varies within at least one layer.

24. A cardiac stent comprising a plurality of elongate struts, wherein at least one strut comprises at least one layer, and wherein at least one material property varies within the layer.

25. The stent according to claim 24, wherein the stent is formed of a polymeric material.

26. The photonic device according to claim 23 or the cardiac stent according to claim 24 or 25, wherein the at least one layer is produced using additive manufacturing.

27. A method of additive layer manufacturing comprising depositing at least one layer of material on a sacrificial layer, the layer of material having a thickness of 400 microns or less;
wherein the sacrificial layer is located on a base surface.

28. The method according to any one of claims 20, or 21 or 22 when dependent on claim 20, or 27, wherein the method further comprises removing the sacrificial layer and the layer of material from the base surface.

29. The method according to any one of claims 20, or 21 or 22 when dependent on claim 20, or 27 or 28, wherein the method further comprises removing the sacrificial layer from the layer of material.

30. The method according to any one of claims 20, or 21 or 22 when dependent on claim 20, or 27-29, wherein the method includes depositing the sacrificial layer on the base surface before depositing the layer of material.

31. The method according to any one of claims 20, or 21 or 22 when dependent on claim 20, or 27-30, wherein the depositing of the sacrificial layer provides a level surface for the deposition of subsequent layers.

32. The method according to any one of claims 20, or 21 or 22 when dependent on claim 20, or 27-31, wherein the same apparatus is used to deposit the sacrificial layer and the layer of material.

33. The method according to any one of claims 20, or 21 or 22 when dependent on claim 20, or 27-32, further comprising applying a pattern to the surface of the sacrificial layer before depositing the layer of material on the sacrificial layer.

34. The method according to any one of claims 20, or 21 or 22 when dependent on claim 20, or 27-33, further comprising controlling the deposition of the sacrificial layer to vary its thickness.

35. The method according to any one of claims 27-34, wherein the method further comprises controlling the deposition to vary at least one material property of the material along the layer.

36. The method according to any one of claims 1-22 and 27-35, wherein the additive layer manufacturing is fused filament fabrication.

37. An object obtainable by the method of any preceding method claim.

38. The object according to claim 37, wherein the object is a cardiac stent.

39. The object according to claim 37, wherein the object is a photonic device.

40. The object according to claim 37, wherein the object contains hidden information represented by the change in material property.

41. The object according to claim 37 or 40, wherein the object is a physical unclonable function.

42. The object according to claim 40 or 41, wherein the hidden information is an image.

43. The object according to any one of claims 40 to 42, wherein the material property is refractive index and/or birefringence.

44. The object according to claim 42 or 43, wherein the image is a colour image.

45. The object according to claim 42 or 43, wherein the image is a black and white image.
